(19) United States
(12) Patent Application Publication
(10) Pub. No.: US 2003/0208623 A1
(43) Pub. Date: Nov. 6, 2003

(54) Appliance number setting member for home network system

(76) Inventor: Masataka Maeda, Konan-shi (JP)

Correspondence Address: Gerald Levy, Esq., PITNEY, HARDIN, KIPP & SZUCH LLP, 711 Third Avenue, New York, NY, 10017-4014, US

(21) Appl. No.: 09/967,423

(22) Filed: Sep. 28, 2001

(30) Foreign Application Priority Data
Feb. 27, 2001 (JP) P2001-052376

(51) Int. Cl. G06F 15/16; G06F 3/00

(52) U.S. Cl. 709/245; 710/9

(57) ABSTRACT

Each of appliance number setting seals 51 to 58 includes a non-conductive seal body 61. The front surface of the non-conductive seal body 61 is formed with text that indicates the type, location, and distinction number of network appliance 20. The rear surface of the non-conductive seal body 61 is provided with at least one seal-side conductive plate 65. When the seal-side conductive plate 65 is attached to contact groups 43, 44, and 45 of the network appliance, electrical characteristic of the contact groups 43, 44, and 45 change, so the network appliance 20 is allotted with an appliance number corresponding to the conductive pattern of the seal-side conductive plate 65.

### BACKGROUND OF THE INVENTION

1. Field of the Invention

The present invention relates to a network system including a plurality of network devices allotted with unique numbers, each communicates with the others while referring to the unique numbers.

2. Related Art

There has been provided a network system where a plurality of network devices are connected to one another. Each of the network devices is allotted with a unique number, so that the network devices can identify each network device by referring to the unique number.

For example, when a network system is formed from a plurality of personal computers (PC), a network manager attaches Ethernet cards to each PC. Each Ethernet card is previously allotted with a unique number called Media Access Control (MAC) address. The PCs in the network system identify the MAC addresses of the Ethernet cards, and transmit data among the PCs via the Ethernet cards while referring to the MAC addresses.

The MAC address is a combination of a manufacturer's unique address, which the Institute of Electrical and Electronics Engineers (IEEE) allots to the manufacturer, and a number allotted to each Ethernet card by the manufacturer. That is, each Ethernet card has it own unique number, which differs from the numbers allotted to any other Ethernet cards on the earth. Accordingly, the MAC address enables to establish a global network system, such as the Internet, enabling identifying each of the devices.

In a conventional small-scale network system including a host computer and devices under the control of the host computer, the devices are provided with dipswitches, which provide means for changing the numbers allotted to the devices. In this system, when a user operates the dipswitch, a circuit provided to the device changes its electrical characteristics, such as a conductive pattern and a nonconductive pattern, so that the number corresponding to the electrical characteristics is allotted to the device. For example, a number allotted to a SCSI device connected to a personal computer via a SCSI interface and a number allotted to a GPIB device connected to a personal computer via a GPIB interface can be changed in this manner.

Home network systems have become increasingly popular recently. More and more average households are introducing home network systems, wherein all of the electric appliances, such as the television, the air conditioner, and lights, in the house are connected to a host computer that executes overall control of the electric appliances.

However, the following problem occurs when setting up a home network system in the conventional manner.

To up a home network system, the user needs to set an appliance number for each of the appliances in the network, so the host computer can recognize and manage all of the appliances. The user can use a MAC address for each appliance to manage the appliances on a global scale. However, MAC addresses are for managing an enormous number of network appliances, so place a large burden on the management system of a small-scale home network system of a general household.

Almost all of the electrical appliances used in a home network system are controlled by the host computer, and so do not independently perform data transmission directly with a broad network. Since MAC addresses are for use in a broad network, it is a waste to use MAC addresses for home network appliances.

Alternately, a user could set an appliance number to each appliance using dipsticks, for example. With this method, the appliance numbers are not global in nature, so are more convenient to manage than MAC addresses. However, the user who sets up the network system must allot a different appliance number to each of the appliances in the network without duplicating appliance numbers.

Normally the homeowner him- or herself sets up and manages a home network system, and so is not necessarily a networking specialist. Whenever the user buys a new appliance and connects it to the system, he or she must recheck all the appliance numbers to make sure that the appliance number allotted to the new appliance is not a duplicate of a previously existing appliance number. The user will feel that setting up and managing such a home network system is extremely troublesome.

### SUMMARY OF THE INVENTION

It is an objective of the present invention to provide a network system wherein appliance numbers are easy to allot and manage even by a person with no special knowledge of networks.

In order to overcome the above and other objects, there is provided a network system including a plurality of network appliances and a plurality of appliance number setting members. Each network appliance distinguishes between other network appliances based on appliance numbers allotted to the network appliances. The plurality of appliance number setting members are formed on a front surface thereof with visible information of a network appliance. The appliance number setting members are for setting a different appliance number to each network appliance. Each network appliance is applied with at least one of the plurality of appliance number setting members.

There is also provided with a network appliance controller for controlling the plurality of network appliances in a network system. The network appliance controller includes a network appliance display that retrieves the appliance numbers of network appliances and appliance number list from a memory medium, and displays at least one of type and location of each network appliance based on the appliance number list.

Further, there is also provided an appliance number setting member including a body having a front surface formed with visible information of a network appliance to allot an appliance number to a network appliance.

There is also provided a network appliance in a network system, including a plurality of contacts that change electrical characteristic when abutted by a conductive pattern of a appliance number setting member, thereby being allotted to an appliance number corresponding to the conductive pattern.

### BRIEF DESCRIPTION OF THE DRAWINGS

The above and other objects, features and advantages of the invention will become more apparent from reading the following description of the embodiment taken in connection with the accompanying drawings in which:

FIG. 1 is a block diagram showing configuration of a home network system according to an embodiment of the present invention;

FIG. 2 is a block diagram showing electrical configuration of a network appliance;

FIG. 3(a) is a schematic view showing a light provided with a setting portion;

FIG. 3(b) is a schematic view showing the setting portion with appliance number settings seals attached;

FIG. 4(a) is a schematic view showing the setting portion without appliance number settings seals;

FIG. 4(b) is a schematic view showing a non-conductive setting plate disposed to the inside of the network appliance;

FIG. 5(a) is a schematic view showing a seal set, which includes appliance number setting seals in all of a possible 255 patterns;

FIG. 5(b) shows a seal-side conductive plate of a “DOOR SENSOR” appliance number setting seal connecting a circular contact and a reference contact of an “APPLIANCE NAME” contact group;

FIG. 5(c) shows two seal-side conductive plates of a “LIGHT” appliance number setting seal connecting two circular contacts and a reference contact of the “APPLIANCE NAME” contact group;

FIG. 5(d) shows a seal-side conductive plate of a “FRONT ENTRANCEWAY” appliance number setting seal connecting a circular contact and a reference contact of a “LOCATION” contact group;

FIG. 5(e) shows two seal-side conductive plates of a “LIGHT” appliance number setting seal connecting two circular contacts and a reference contact of a “No.” contact group;

FIG. 6 is a block diagram showing electrical configuration of a host computer of the home network system;

FIG. 7 is a schematic view representing an appliance number list stored in a hard disk of the host computer;

FIG. 8 is a flowchart representing a connected appliance search routine of the host computer; and

FIG. 9 is a schematic view representing a connected appliance list displayed on a display device by the host computer.

### DETAILED DESCRIPTION OF THE EMBODIMENT

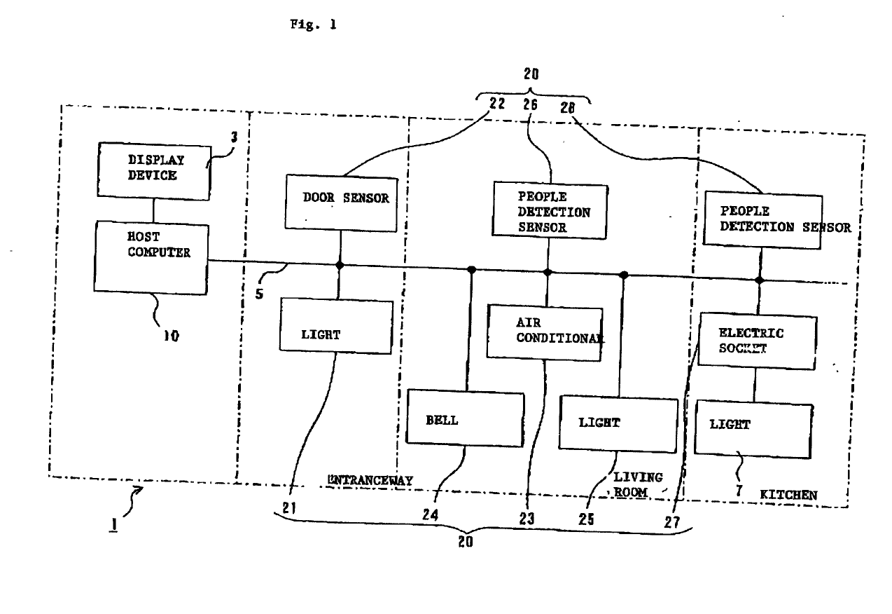

Next, a home network system 1 according to an embodiment of the present invention will be described while referring to the attached drawings. FIG. 1 is a block diagram representing the home network system 1 installed in a home.

As shown in FIG. 1, the home network system 1 includes a host computer 10, which is connected to a display device 3. A transmission cable 5 is provided to connect a variety of network appliances 20 to the host computer 10. The network appliances include lights 21, 25, a door sensor 22, people detection sensors 26, 28, an air conditioner 23 set up in the living room, a bell 24, and an electric socket 27 located in the kitchen. The light 21 is located in the entranceway of the house. The door sensor 22 monitors opening and closing movement of the front door. The people detection sensor 26 monitors whether anyone is in the living room. The people detection sensor 28 monitors whether anyone is in the kitchen.

The host computer 10 performs overall control of the network appliances 20 located in the front entranceway, the living room, and the kitchen. For example, if the host computer 10 receives a signal over the cable 5 from the door sensor 22 located in the front entranceway, indicating that the front door has opened up, then the host computer 10 transmits a signal to the light 21 located in the front entranceway. The transmitted signal turns on the power source of the light 21 located in the front entranceway so that the light 21 turns on. The host computer also controls the bell 24 located in the living room to ring.

If someone enters the living room, the people detection sensor 26 transmits a signal to the host computer 10, indicating that someone is in the living room. The host computer 10 receives the signal and controls the air conditioner 23 and the light 25 to turn on their power sources.

Also, the computer 10 controls the electric socket 27, which is a network appliance 20 located in the kitchen, to turn on and off supply of power to whatever electric appliances are connected to the electric socket 27

For example, when a light 7 is connected to the electric socket 27, the host computer 10 can ON/OFF control the light 7 by controlling the electric socket 27, even if the light 7 is not provided with any means for connecting to the home network system 1.

Upon detection of someone in the kitchen, the people detection sensor 28 outputs a detection signal to the host computer 10. The host computer 10 turns ON the power supply of the electric socket 27 to the light 7, and so the light 7 is turned ON.

FIG. 2 is a block diagram showing main electric components of each of the network appliances 20. As shown, each network appliance 20 includes a transceiver 33, a setting portion 40, and a microprocessing unit(MPU) 31. The MPU 31 is for executing overall control of the network appliance 20, and the transceiver 33 and the setting portion 40 are individually connected to the MPU 31. The transceiver 33 is connected to the communication cable 5. The setting portion 40 is for allotting an appliance number to the network appliance 20 when a appliance number setting seal (described later) is sealed thereon.

Upon reception of a signal from the host computer 10 inquiring appliance numbers of the network appliances 20 of the home network system 1, the MPU 31 retrieves the appliance number for the setting portion 40 and sends information an the retrieved appliance number to the host computer 10. Also, when the host computer 10 transmits a signal appended with an appliance number to the MPU 31 of each network appliance 20 via the transceiver 33, each network appliance 20 detects the appliance number appended to the received signal, and determines whether the appliance number matches to its own appliance number. When matches, the network appliance 20 electrically controls its own components in accordance with the signal from the host computer 10. In this way, each network appliance 20 executes command in response only to a corresponding signal identified based on the appliance number.

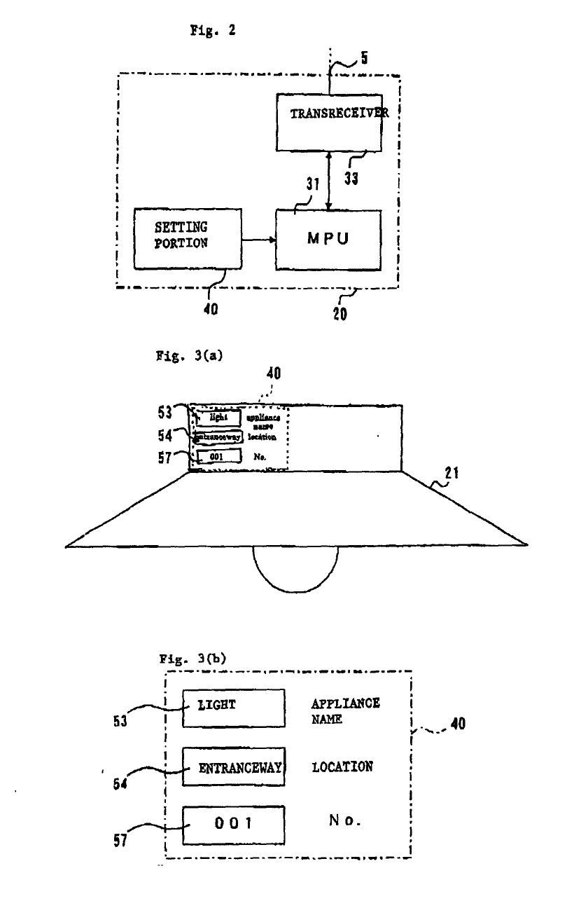

The setting portion 40 provided to each of the network appliances 20 has a configuration shown in FIGS. 3(a) and 3(b), and is attached with the appliance number setting seal, which sets an appliance number to each network appliance 20 without duplicating the appliance number.

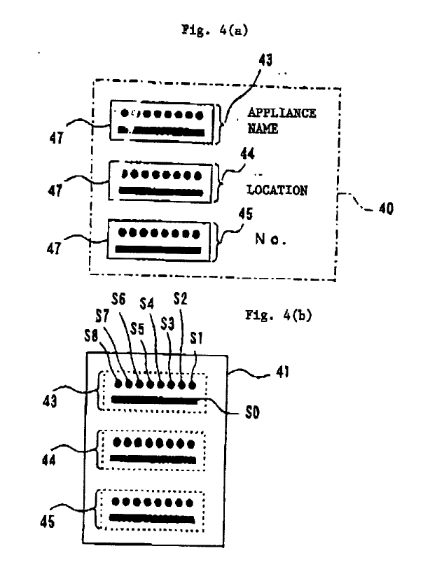

Here, FIG. 3(a) is a front view of the light 21, and FIG. 3(b) is an enlarged front view showing the components of the setting portion 40. FIG. 4(a) is a front view of the setting portion 40 without the appliance number setting seal, and FIG. 4(b) is a front view of a setting board 41 to be described later.

Explained in more detail, the setting portion 40 includes a non-conductive setting plate 41 disposed to the inside of the network appliance 20. The setting plate 41 is formed on its surface with three conductive contact groups 43, 44, and 45. Before the appliance number setting seals are attached, the three contact groups 43, 44, and 45 are exposed to the outside of the network appliance 20 through windows 47 provided in the network appliance 20.

The contract groups 43, 44, and 45 are arranged in this order from top to bottom in vertical alignment. The contact group 43 is attached with an appliance number setting seal that indicates the type of network appliance 20. The contact group 44 is attached with an appliance number setting seal that indicates the location of the network appliance 20. The contact group 45 is attached with an appliance number setting seal that indicates a distinction number. The distinction number is used to display the network appliances 20 on a display screen to be described later in a manner that enables the user to distinguish between a plurality of the same type of network appliances 20 that are located in the same area.

Each contact group 43, 44, and 45 includes a reference contact S0 and eight circular contacts S1 to S8 on the surface of the non-conductive setting plate 41. Each reference contact S0 is formed from a conductive pattern formed in a rectangular shape that is elongated in the horizontal direction. The rectangular shape is shorter in the horizontal direction than the horizontal width of windows 47 that are formed in the setting portion 40 and is sufficiently shorter in the vertical direction than the vertical width of the windows 47. The eight circular contacts S1 to S8 are each formed from a circular conductive pattern that is separated from the reference contact S0 by a predetermined distance. The eight circular contacts S1 to S8 are aligned equidistance from each other in a row that extends parallel with the reference contact S0.

The reference contact S0 and the eight circular contacts S1 to S8 are each connected to terminals of the MPU 31 provided in the network appliance 20. When an appliance number setting seal to be described later is attached to the contact groups 43, 44, and 45, electrical characteristic of the contact groups 43, 44, and 45 are changed, and the MPU 31 reads the appliance number from the electrical characteristic of the contact groups 43, 44, and 45.

That is, the MPU 31 judges whether or not appliance number setting seals have brought the circular contacts S1 to S8 into electrical connection with the reference contact S0. The MPU 31 reads the connection condition of each contact group as an eight-bit digital value to determine the appliance number of the network appliance 20.

As shown in FIG. 4(a), the text “APPLIANCE NAME,” “LOCATION,” and “No.” are printed on the surface of the setting portion 40 to the right of the windows 47, 47, 47 that expose the contact groups 43, 44, and 45. This text indicates to the user which contact groups 43, 44, and 45 correspond to which appliance number setting seals, which, as will be described later, are inscribed with the type, location, or distinction number of the network appliance 20.

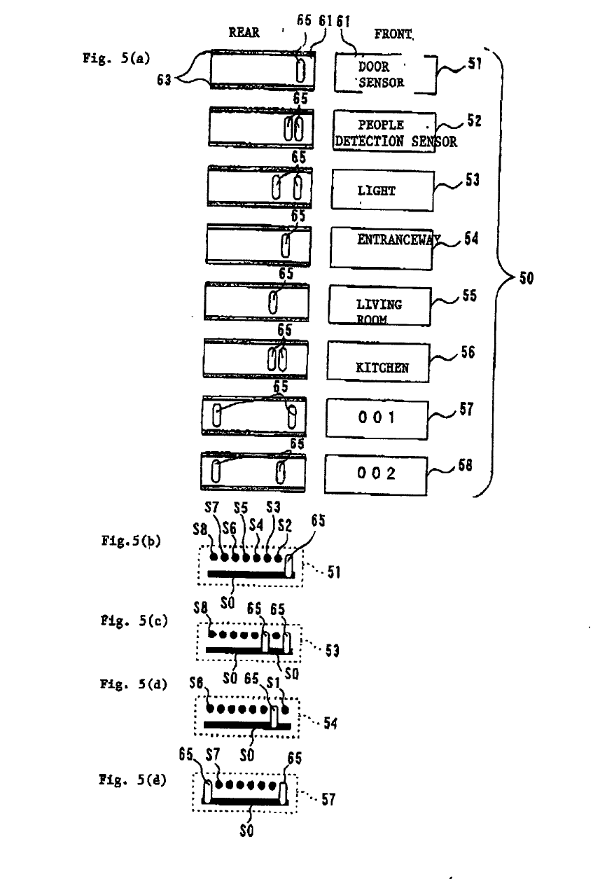

FIG. 5(a) shows the configuration of the appliance number setting seals 51 to 58 that are attached to the contact groups 43, 44, and 45. It should be noted that FIG. 5(a) is a schematic view representing the front and rear surfaces of the appliance number setting seals 51 to 58.

As shown in FIG. 5(a), each of the appliance number setting seals 51 to 58 includes a non-conductive seal body 61 with substantially the same rectangular shape as the window 47 of the setting portion 40. The front surface of the non-conductive seal body 61 is formed with text that indicates the type, location, and distinction number of the network appliance 20. The rear surface of the non-conductive seal body 61 is coated with an adhesive along the longitudinal edges.

Further, one or more elongated conductive metal plates 65 are fixed in the center of the rear surface. The conductive metal plates 65 extend in the vertical direction, which is perpendicular to the lengthwise direction of the seal body 61. According to the present embedment, each appliance number setting seal has at least one, and not more than eight, conductive metal plates 65. The conductive metal plates 65 will be referred to as seal-side conductive plates 65 hereinafter.

That is, the seal-side conductive plates 65 are distributed on the rear surface of each of the appliance number setting seals 51 to 58 in one of 255 possible different patterns that can be formed using a maximum of either seal-side conductive plates 65. When an appliance number setting seal 51 to 58 is attached to contact groups 43, 44, 45 of the setting portion 40, each seal-side conductive plate 65 contacts the reference contact S0 and the one circular contact S1 to S8 that corresponds to the position of the seal-side conductive plate 65 on the appliance number setting seal 51 to 58. It should be noted that the appliance number setting seals 51 to 58 that have a plurality of seal-side conductive plates 65 fixed to the rear surface are configured so that the plurality of seal-side conductive plates 65 do not overlap on the same circular contacts S1 to S8.

FIG. 5(b) shows the condition when the appliance number setting seal 51 inscribed on its front surface with the text “DOOR SENS0R” is attached to the contact group 43. It should be noted that FIG. 5(b) shows the seal body 61 as being transparent.

FIG. 5(b) shows the right-hand circular contact S1 connected with the reference contact S0 through the seal-side conductive plate 65 fixed to the right side end of the rear surface of the seal body 61. When any of the appliance number setting seals 51 to 58 is attached to one of the contact groups 43, 44, 45 of the setting portion 40 in this way, the seal-side conductive plate or plates 65 bring the circular contact S1 to S8 at the corresponding location into electrical connection with the reference contact S0.

The appliance number setting seals 51 to 58 are sold to users who design home network systems in a seal set 50, which includes appliance number setting seals in all possible 255 patterns. The user uses the seal set 50 to designated appliance numbers to all network appliances 20.

FIG. 3 shows the light 21 located in the front entranceway. The light 21 will be explained as an example of a network appliance 20. The user selects the appliance number setting seal 53 inscribed on its front surface with the text “LIGHT” from the seal set 50 shown in FIG. 5(a), and attaches the appliance number setting seal 53 onto the upper-most contact group 43 with the rear surface facing toward the contact group 43. Further, the user selects the appliance number setting seal 54 inscribed on its front surface with the text “FRONT ENTRANCEWAY,” and attaches it to the center contact group 44. Then, the user selects the appliance number setting seal 57 inscribed on its front surface with the numbers “001,” and attaches it to the lower-most contact group 45. In this way, the user sets an appliance number to the light 21 located in the front entranceway.

FIG. 5(c) shows the seal body 61 as though it were transparent, in order to reveal the condition of the appliance number setting seal 53 and the contact group 43 when the appliance number setting seal 53 is attached to the contact group 43. FIG. 5(d) shows the seal body 61 as though it were transparent, in order to reveal the condition of the appliance number setting seal 54 and the contact group 44 when the appliance number setting seal 54 is attached to the contact group 44. FIG. 5(e) shows the seal body 61 as though it were transparent, in order to reveal the condition of the appliance number setting seal 57 and the contact group 45 when the appliance number setting seal 57 is attached to the contact group 45.

As can be seen in FIG. 5(c), the seal-side conductive plates 65 on the rear surface of the appliance number setting seal 53 inscribed on its front surface with the text “LIGHT” bring the reference contact S0 of the upper-most contact group 43 into electrical connection with the circular contacts S1 and S3 of the circular contacts S1 to S8. Accordingly, the MPU 31 recognizes the electrical characteristic obtained through the terminal connected to the upper-most contact group 43 as an upper appliance number of 00000101, which was set for the network appliance 20 using the appliance number setting seal 53.

As shown in FIG. 5(d), the seal-side conductive plates 65 on the rear surface of the appliance number setting seal 54, which is inscribed on its front surface with the text “FRONT ENTRANCEWAY,” connect the circular contact S2 of the central contact group 44 to the reference contact S0. The MPU 31 recognizes the electrical characteristic obtained through the terminal connected to the central contact group 44 as the center appliance number 00000010, which was set for the network appliance 20 using the appliance number setting seal 54.

As shown in FIG. 5(e), the seal-side conductive plates 65 on the rear surface of the appliance number setting seal 57, which is inscribed on its front surface with the numbers “001,” connect the circular contacts S1 and S8 of the lower-most contact group 45 to the reference contact S0. The MPU 31 recognizes the electrical characteristic obtained through the terminal connected to the lower-most contact group 45 as the lower appliance number 10000001, which was set for the network appliance 20 using the appliance number setting seal 57.

The MPU 31 judges from the upper, center, and lower appliance numbers that the appliance number set for the network appliance 20 by the three appliance number setting seals is “000001010000001010000001.”

Accordingly, when the user introduces a plurality of network appliances 20 into the home network system 1, the user can set unique, non-repetitive appliance numbers to the network appliances 20 by merely selecting appliance number setting seals from the same seal set 50 and attaching them to the network appliances 20.

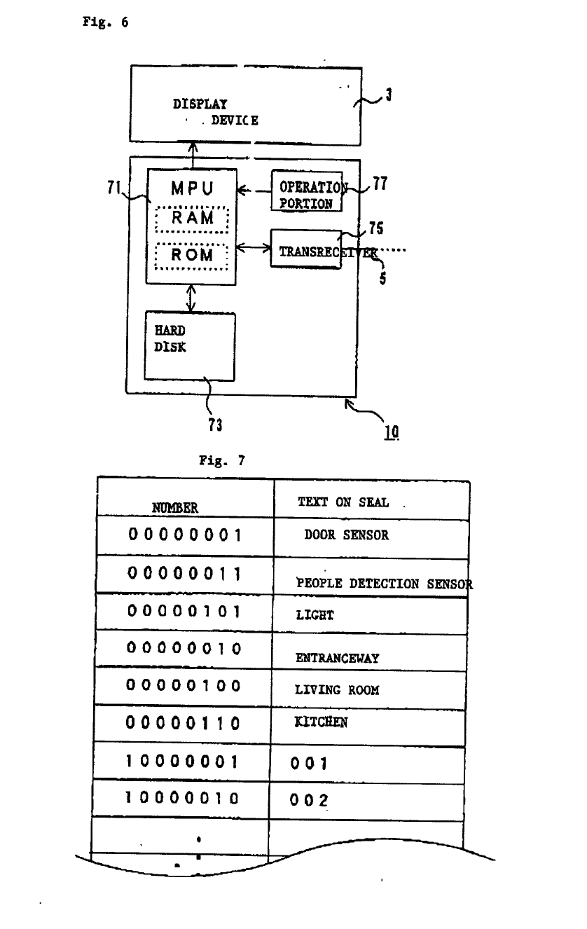

Above, the network appliances 20 that are controlled by the host computer 10 were explained. Next, an explanation will be provided for the configuration for the host computer 10 while referring to FIG. 6. It should be noted that FIG. 6 is a block diagram showing configuration of the host computer 10.

As shown in FIG. 6, the host computer 10 includes the MPU 71, a hard disk 73, a transceiver 75, and an operation portion 77. The hard disk 73 serves as a memory medium. The transceiver 75 is for performing transmissions with the network appliances 20 across the transmission cable 5. The operation portion 77 is for the user to input commands into the host computer 10 from external operations. The hard disk 73 stores an appliance number list represented by the schematic view of FIG. 7. The appliance number list shows the correspondence relationship between the text on the front surface of the appliance number setting seals 51 to 58 provided to the user in the seal set 50 and the numbers recognized by the MPU 31 of the network appliance 20 based on the conductive pattern formed on the rear surface of the appliance number setting seals 51 to 58.

The hard disk 73 also stores a computer program executed by the MPU 71 of the host computer 10 to perform a connected appliance search routine to be described later. During the connected appliance search routine, the host computer 10 searches through the network appliances 20 connected to the home network system 1 to obtain the appliance number of each network appliance 20. Based on the searched appliance numbers and the appliance number list, the host computer 10 displays a list on the display device 3 of the type and location of network appliances 20 connected to the home network system 1.

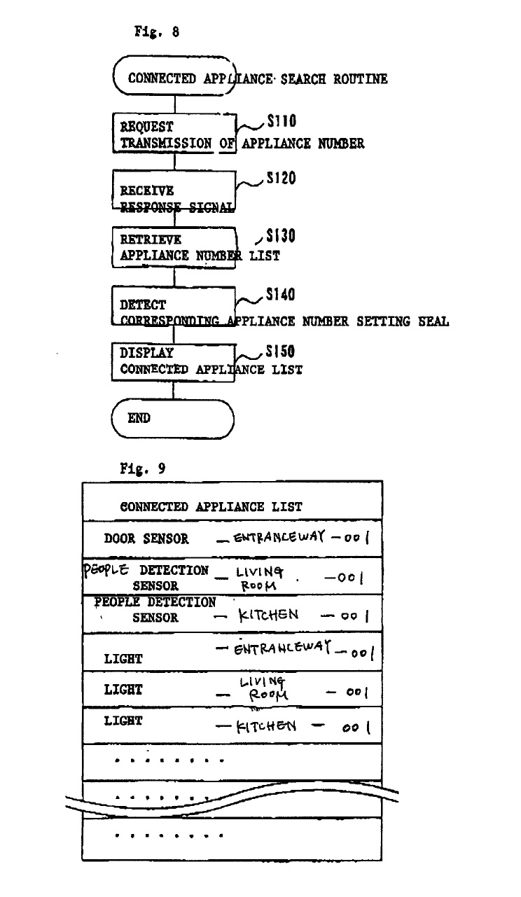

FIG. 8 is a flowchart representing processes performed during the connected appliance search routine. The MPU 71 executes the connected appliance search routine when the host computer 10 is started up. When the routine is started, first in S110 the MPU 71 requests that all network appliances 20 connected to the cable 5 transmit the appliance number that is set by the setting portion 40 to the host computer 10. In S120, the MPU 71 obtains the appliance numbers of the network appliances 20 in responses transmitted from the network appliances 20.

When S120 is completed, then in S130 the MPU 71 retrieves the appliance number list from the hard disk 73. In S140, the MPU 71 divides the appliance numbers obtained in S120 for a plurality of network appliances 20 into upper, center, and lower appliance numbers. The MPU 71 searches the appliance number list for appliance number setting seals 51 to 58 that correspond to the upper, center, and lower appliance numbers and obtains the text written on the front surface of those appliance number setting seals 51 to 58. In S150, the MPU 71 controls the display device 3 to display a list of network appliances 20 connected to the host computer 10 using the text inscribed on the front surface of the obtained appliance number setting seals. The list of network appliances 20 connected to the host computer 10 will be referred to as the connected appliance list hereinafter. FIG. 9 shows a connected appliance list displayed on the screen of the display device 3.

For example, when the light 21 shown in FIG. 3 transmits the appliance number “000001010000001010000001” to the host computer 10, the host computer 10 divides this into an eight-digit upper number “00000101,” an eight-digit center number “00000010,” and an eight-digit lower number “10000001.” The MPU 71 then searches out the appliance number setting seals 53, 54, 57, which correspond to these numbers. Then the MPU 71 controls the display device 3 to display the text “LIGHT” written on the front surface of the appliance number setting seal 53, the text “FRONT ENTRANCEWAY” written on the front surface of the appliance number setting seal 54, and the appliance number “001” written on the front surface of the appliance number setting seal 57 horizontally aligned in a row as shown in FIG. 9. Further, in the same way, the MPU 71 uses the appliance numbers of the other network appliances 20 to search out the corresponding appliance number setting seals and displays the characters inscribed on the front surfaces of the appliance number setting seals aligned in separate horizontal rows.

Because the host computer 10 controls the display device 3 to display the connected appliance list showing type and location of the network appliances 20 connected to the home network system 1, the user can easily know the connection condition of network appliances 20 connected in the home network system 1.

In a home network system with appliance numbers set using dipsticks and the like in the conventional manner, the user could not know the location of network appliances 20 even by using the host computer 10 to scan the connected network appliances 20. However, by using the appliance number setting seals 51 to 58 of the present embodiment to set appliance numbers, the user will not only be able to easily tell the type of network appliance 20, but also the location by merely viewing the screen of the host computer 10.

As described above, the network system of the present invention is configured so that each appliance number setting member sets a preset individual number to each network appliance, Therefore, when the user connects a new network appliance to the network system, the user can easily use the appliance number setting member to allot an appliance number to the new appliance, without fear of duplicating an appliance number that is already used in the system.

Also, because the appliance number setting member has a simple configuration, the producer of the appliance number setting members can produce the appliance number setting members inexpensively, and the user can set appliance numbers to the network appliances inexpensively using the appliance number setting members.

When a new network appliance is connected to the network, the user does not need to recheck the appliance number of all the existing network appliances, as is required in the conventional case. As a result, the network system according to the present invention frees the user from such troublesome work.

Also, because the appliance number setting members include visible information that indicates the type and location of the network appliances, the user can set an appliance number to each network appliance based on the visible information. That is, the appliance number setting member can be provided with a special number, such as one of a consecutive set of numbers, that indicates the type and location of the network appliance.

The invention can be effectively utilized when it is know that a network appliance performs transmission with only a particular type of network appliance. In this case, the user sets the network appliance with a number that indicates relation to the certain type of network appliance. This enables the host computer to easily designate the target of transmission for the network appliance to be the particular type of network appliance.

Also, by storing the appliance number list in a hard disk, for example, of one of the network appliances connected to the display device, the network appliance can display the type and location of the other network appliances connected to the system, on a screen along with display of the appliance number, based on the appliance number obtained from the other network appliances connected to the system.

When the network appliances can be identified based on the type and location of the network appliances, the user can easily grasp which appliance number is allotted to which network appliance if the user is notified of the correspondence relationship between the appliance number and the type and location of the appliance.

While the invention has been described in detail with reference to specific embodiments thereof, it would be apparent to those skilled in the art that various changes and modifications may be made therein without departing from the spirit of the invention, the scope of which is defined by the attached claims.

For example, the host computer 10 can control the display device 3 to display the operation condition of the network appliances 20 at the same time as displaying the connected appliance list. In this case, the host computer 10 requests transmission operation condition from the network appliances 20 when requesting transmission of appliance numbers. The host computer 10 then displays the operation condition obtained in the response signals from the network appliances 20 and displays the operation condition with the connected appliance list.

With this configuration, the user will be able to easily grasp the information in the connected appliance list and also, for example, whether lights are turned on, whether the air conditioner is running, and other information. This is convenient for the user.

Also, the host computer 10 can be provided with a computer program that controls the network appliances 20 when the user uses the operation portion 77 to select network appliances 20 from the connected appliance list. This enables the user to easily set network appliances 20 without knowing the appliance number of the network appliances 20.

The appliance number setting members need not be the appliance number setting seals described in the embodiment, but could be, for example, conductive plates formed on the front surface of plastic plates instead.

Further, more than eight circular contacts can be provided in each contact group and more than eight seal-side conductive plates can be formed on the rear surface of the appliance number setting seals. By increasing the number of circular contacts, the number of appliance number that can be set to network appliances 20 can be increased. Therefore, the present invention can be applied to a larger network system with a larger number of network appliances 20.

The memory medium for storing the appliance number list need not be a hard disk, but could be a memory, a CD-ROM, or a paper sheet instead.

What is claimed is:

1. A network system comprising:
a plurality of network appliances, each network appliance distinguishing between other network appliances based on appliance numbers allotted to the network appliances; and
a plurality of appliance number setting members each having a front surface inscribed with visible information of a network appliance, the appliance number setting members being for setting a different appliance number to each network appliance, wherein each network appliance is applied with at least one of the plurality of appliance number setting members.

2. The network system as claimed in claim 1, further comprising a memory medium storing an appliance number list representing correspondence relationship between:
the appliance numbers that the appliance number setting members allot to the network appliances; and
the visible information formed on the appliance number setting members.

3. The network system as claimed in claim 2, wherein the visible information represents at least one of type, location, and number of the network appliance.

4. The network system as claimed in claim 3, further comprising a controller for controlling the plurality of network appliances, the controller including a network appliance display that retrieves the appliance numbers of the network appliances and the appliance number list from the memory medium, and displays at least one of type and location of each network appliance based on the appliance number list.

5. The network system as claimed in claim 2, wherein the appliance number setting members each have a rear surface made from a non-conductive material formed with a conductive pattern that corresponds to the visible information formed on the front surface, the appliance number setting member being mounted onto the network appliance with the conductive pattern abutting the network appliance.

6. The network system as claimed in claim 4, wherein the network appliance includes a plurality of contacts that change electrical characteristic when abutted by the conductive patterns of the appliance number setting members.

7. The network system as claimed in claim 5, further comprising a controller for controlling the plurality of network appliances, the controller detecting the electrical characteristic of the plurality of contacts of the network appliance, as a digital value.

8. The network system as claimed in claim 5, wherein the controller detects the visible information of the appliance number setting members based on the detected visible value.

9. A network appliance controller for controlling the plurality of network appliances in the network system of claim 3, comprising:
a network appliance display that retrieves the appliance numbers of the network appliances and the appliance number list from the memory medium, and displays at least one of type and location of each network appliance based on the appliance number list.

10. An appliance number setting member comprising:
a body having a front surface formed with visible information of a network appliance to allot an appliance number corresponding to the visible information to a network appliance.

11. The appliance number setting member as claimed in claim 10, wherein the body has a non-conductive rear surface formed with a conductive pattern that corresponds to the visible information.

12. The appliance number setting member as claimed in claim 10, wherein the visible information represents at least one of type, location, and number of the network appliance.

13. A network appliance in a network system, comprising:
a plurality of contacts that change electrical characteristic when abutted by a conductive pattern of a appliance number setting member, thereby being allotted to an appliance number corresponding to the conductive pattern.
